(19) United States
(12) Patent Application Publication
(10) Pub. No.: US 2026/0064759 A1
(43) Pub. Date: Mar. 5, 2026

(54) STRUCTURED RETRIEVAL-AUGMENTED GENERATION

(71) Applicant: Microsoft Technology Licensing, LLC, Redmond, WA (US)

(72) Inventors: Umesh MADAN, Bellevue, WA (US); Steven Edward LUCCO, Bellevue, WA (US)

(73) Assignee: Microsoft Technology Licensing, LLC, Redmond, WA (US)

(21) Appl. No.: 18/818,470

(22) Filed: Aug. 28, 2024

(51) Int. Cl. G06F 16/36

(52) U.S. Cl. CPC G06F 16/367

(57) ABSTRACT

A computing system including one or more processing devices configured to extract ontology elements from conversational turns. The ontology elements are extracted at least in part by executing a generative language model. The one or more processing devices assign a respective ontology element type to each ontology element and store the ontology elements in an ontology index. The one or more processing devices receive a user input, and, at the generative language model, compute a structured retrieval-augmented generation (RAG) query. The one or more processing devices execute the structured RAG query over the ontology index to obtain one or more retrieved ontology elements. At the generative language model, the one or more processing devices compute and output a generative language model output based at least in part on the user input and the one or more retrieved ontology elements.

### BACKGROUND

Recently, machine learning (ML) models have been increasingly incorporated into scaffolded ML systems that integrate those ML models into larger computing workflows. For example, a scaffolded machine learning system may utilize a large language model (LLM) or large multimodal model (LMM) for complex tasks such as natural language processing but may instead execute less computationally expensive deterministic code to perform simpler computing processes. These scaffolded ML systems include logic that selectively calls one or more ML models under predefined conditions.

In many scaffolded ML systems, at least a portion of a prompt to a ML model is programmatically generated. By programmatically generating at least a portion of the prompt rather than relying solely on user input to the ML model, inferencing performed at the ML model may be guided more precisely. Thus, programmatic prompt generation may be used to increase the reliability of the ML model.

### SUMMARY

According to one aspect of the present disclosure, a computing system is provided, including one or more processing devices configured to extract a plurality of ontology elements from a plurality of conversational turns. The ontology elements are extracted from the conversational turns at least in part by executing a generative language model included in the machine learning system. The one or more processing devices are further configured to assign a respective ontology element type to each of the ontology elements. The one or more processing devices are further configured to store the ontology elements in an ontology index at one or more memory devices. Within the ontology index, the ontology elements are organized according to their ontology element types. The one or more processing devices are further configured to receive a user input to the machine learning system. At the generative language model, the one or more processing devices are further configured to compute a structured retrieval-augmented generation (RAG) query based at least in part on the user input. The one or more processing devices are further configured to execute the structured RAG query over the ontology index to obtain one or more retrieved ontology elements from the ontology index. At the generative language model, the one or more processing devices are further configured to compute a generative language model output based at least in part on the user input and the one or more retrieved ontology elements. The one or more processing devices are further configured to output the generative language model output.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system at which structured retrieval-augmented generation (RAG) is performed, according to one example embodiment.

FIG. 2 schematically shows an example ontology index, according to the example of FIG. 1.

FIG. 3 schematically shows ontology entity extraction and storage in additional detail, according to the example of FIG. 1.

FIG. 4 schematically shows ontology entity retrieval in additional detail, according to the example of FIG. 1.

FIG. 5 schematically shows an example in which unstructured RAG is performed after an exact-match and/or fuzzy match search returns no matches, according to the example of FIG. 1.

FIG. 6 schematically shows an example in which an aggregated ontology element is computed from a subset of the ontology index, according to the example of FIG. 1.

FIG. 7 schematically shows an example in which a portion of a conversation history is retrieved and used to generate a generative language model output, according to the example of FIG. 1.

FIG. 8A shows a flowchart of a method for use with a computing system to perform structured RAG, according to the example of FIG. 1.

FIGS. 8B-8F show additional steps of the method of FIG. 8A that may be performed in some examples.

FIG. 9 shows a schematic view of an example computing environment in which the computing system of FIG. 1 may be instantiated.

### DETAILED DESCRIPTION

Retrieval-augmented generation (RAG) is an existing technique that can be used to insert stored data into the prompt of an ML model. In RAG, a vector database stores a plurality of database records in vectorized form. Subsequently to storing the database records in the vector database, the ML system receives input data, such as a portion of a user input expressed in natural language. The ML system is further configured to perform a preprocessing stage on the input data to generate the prompt. During the preprocessing stage, the input data is encoded in vectorized form. The ML system then computes similarity values between the vectorized input data and the vectorized database records to select one or more of the database records for inclusion in the prompt. For example, the vectorized database record with the highest cosine similarity may be selected. In other examples, each vectorized database record with a respective cosine similarity value above a predetermined cutoff may be selected for inclusion. Thus, RAG may be used to retrieve database records that are close to the input data in embedding space. RAG allows an ML model to retrieve information from outside its context window, thereby extending the set of ML model inputs to include additional sources of potentially relevant information.

Existing RAG approaches are insufficiently precise for some ML applications. In the vector database used in RAG, the database records are stored as raw vectors without accounting for structural or semantic relationships between those database records. Since the vectors are stored and retrieved without utilizing contextual information, false-positive retrievals may occur. For example, as the number of discrete text blocks encoded in the vector database increases, the number of approximate nearest-neighbor matches also increases. This increase in the number of approximate nearest-neighbor matches can increase the probability of erroneously retrieving an irrelevant database record. In addition, as the number of stored records increases, the computational costs associated with checking vector similarity also grow. Therefore, when used with large vector databases, RAG may tend to produce ML model hallucinations as a result of erroneous retrieval.

RAG typically uses cosine similarity with a predetermined similarity cutoff when selecting database records. However, this approach to similarity determination may also lead to inaccurate retrieval. The selection of the predetermined similarity cutoff is at least somewhat arbitrary. Depending on the selected value of the predetermined similarity cutoff, the ML system may tend to select irrelevant database records or exclude relevant database records.

The vector encodings used in RAG are also generated in an imprecise manner. The vector encodings are computed at a vector encoding model such as ada-02. Vector encoding models used for RAG typically have less detailed representations of natural language compared to LLMs such as GPT-4 and may therefore fail to accurately model user intent and other semantic contents of natural-language inputs.

In order to address the shortcomings of existing RAG approaches discussed above, structured RAG techniques are provided herein. As discussed in further detail below, structured RAG utilizes an ontology index instead of the unstructured vector databases used in previous RAG approaches. The ontology index encodes semantic relationships between the database records stored therein. The ontology index also allows for the use of more precise retrieval techniques than cosine similarity matching.

Classical artificial intelligence (AI) systems, which are AI systems that do not utilize neural networks, sometimes include ontology databases. These ontology databases store world-models that encode semantic relationships between different entities. Examples of these ontology databases include Cyc, WordNet, and COSMO. Ontology databases allow for retrieval of exact indications of semantic relationships. In addition, an ontology database may have more structure than the unstructured vector databases used in RAG, which may allow the ontology database to specify the relationships between stored entities in greater detail. However, conventional ontology databases used in classical AI lack the flexibility and detail of the world-models that arise in LLMs and LMMs during training. In addition, ontology databases may be difficult and time-consuming to construct and often require large amounts of manual labeling.

The structured RAG systems and methods discussed herein use a generative language model to programmatically and dynamically construct an ontology index from conversations between a user and the generative language model. In contrast to the ontologies used in classical AI, the systems and methods discussed below generate the ontology index over the course of ontology element extraction without requiring user curation to define the structure of the ontology index. In addition, the generative language model is used when generating queries to the ontology index. Retrieved ontology elements are inserted into the context of the generative language model and used to compute responses that are sent to the user. By using the generative language model to construct and query the ontology index, structured RAG may efficiently generate an ontology index that allows for greater precision in retrieval than traditional RAG. Accordingly, the structured RAG approaches discussed herein may achieve the advantages of both RAG and ontology databases.

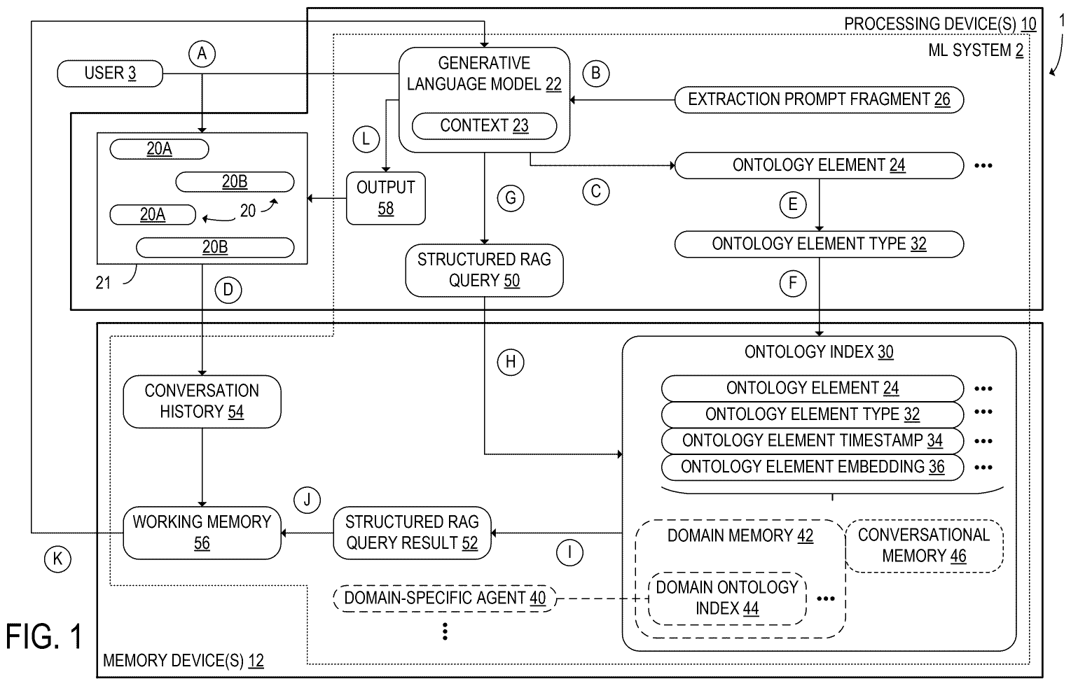

FIG. 1 schematically shows a computing system 1, according to one example embodiment. The computing system 1 includes one or more processing devices 10 and one or more memory devices 12. The one or more processing devices 10 may, for example, include one or more central processing units (CPUs), graphics processing units (GPUs), neural processing units (NPUs), and/or other types of hardware accelerators. The one or more memory devices 12 may, for example, include one or more volatile memory devices and one or more non-volatile storage devices.

In some examples, the one or more processing devices 10 and/or the one or more memory devices 12 may include a plurality of physical components distributed among a plurality of different physical computing devices. For example, the one or more processing devices 10 and/or the one or more memory devices 12 may be included in a networked system of multiple physical computing devices located in a data center. Portions of the functionality of the one or more processing devices 10 and/or the one or more memory devices 12 may additionally or alternatively be performed at one or more client computing devices.

FIG. 1 shows an example sequence of steps that may be performed at the computing system 1 to perform structured RAG. At step A, a plurality of conversational turns 20 are exchanged between a machine learning (ML) system 2 and one or more users 3. The conversational turns 20 shown in this example are exchanged over a graphical user interface (GUI) 21. The GUI 21 may be displayed to the user 3 and may receive user input at a client computing device included in the computing system 1. The conversational turns 20 include a plurality of user inputs 20A as well as a plurality of responses 20B generated at the ML system 2. In some examples, the conversational turns 20 take the form of text. Other types of data, such as image data, audio data, and/or video data, may additionally or alternatively be exchanged in the plurality of conversational turns 20. For example, inputs and outputs that have multiple different data types may be exchanged during interactions between a user 3 and an ML system 2 that includes an LMM.

The ML system 2 that interacts with the user 3 includes a generative language model 22 along with additional programming logic and data sources that collectively form the scaffolding of the ML system 2. In some examples, a plurality of different ML models may be included in the ML system 2. For example, the plurality of ML models may be associated with different domains, as discussed in further detail below, or configured to process different data types.

The one or more processing devices 10 are further configured to extract a plurality of ontology elements 24 from the conversational turns 20. The ontology elements 24 are extracted from the conversational turns 20 at least in part by prompting the generative language model 22 with instructions to extract the ontology elements 24. The ontology elements 24 are indicators of semantic content, such as objects, actions, properties, or relationships, that occur in the conversational turns 20.

At step B, in order to extract the one or more ontology elements 24, the one or more processing devices 10 are configured to insert an extraction prompt fragment 26 into a context 23 of the generative language model 22. Thus, at step C, the one or more processing devices 10 are configured to extract the ontology elements 24 based at least in part on the context 23 that includes the extraction prompt fragment 26.

The extraction prompt fragment 26 may, for example, be a natural-language instruction to identify one or more ontology elements 24 in the conversational turns 20. In other examples, the extraction prompt fragment 26 may be a prompt fragment that has been constructed to elicit ontology element extraction but is not written in natural language. The extraction prompt fragment may, in some examples, be inserted into the context 23 at a predefined interval, such as at every user input 20A or every second user input 20A. In other examples, the extraction prompt fragment 26 may be included in the system prompt of the generative language model 22.

By using an extraction prompt fragment 26, the one or more processing devices 10 may be configured to extract the ontology elements 24 in parallel with generation of respective responses 20B. The one or more processing devices 10 may accordingly increase the efficiency of ontology element extraction in terms of time and processing by avoiding additional calls to the generative language model 22.

At step D, the one or more processing devices 10 are further configured to store, in the one or more memory devices 12, a conversation history 54 including the plurality of conversational turns 20. The one or more processing devices 10 are accordingly configured to store the conversational turns 20 for later reference when generating responses 20B to user inputs 20A.

At step E, subsequently to extracting the ontology elements 24, the one or more processing devices 10 are further configured to assign a respective ontology element type 32 to each of the ontology elements 24. For example, an ontology element “author” may be assigned the “occupation” ontology element type. As another example, an ontology element “reschedule” may be assigned the “calendar interaction” ontology element type. When assigning the ontology element types 32, the one or more processing devices 10 are configured to use the semantic modeling capabilities of the generative language model 22 to select ontology element types 32 that are applicable to the corresponding ontology elements. The assignment of the ontology element types 32 may be performed at the generative language model 22 in parallel with extraction of the ontology elements 24.

At step F, the one or more processing devices 10 are further configured to store the ontology elements 24 in an ontology index 30 at the one or more memory devices 12. The ontology index 30 stores the ontology elements 24 and their respective ontology element types 32 in a structured manner, as discussed in further detail below. Ontology elements 24 extracted from the conversational turns 20 may be stored in conversational memory 46 included in the ontology index 30.

In the example of FIG. 1, the ontology index 30 further stores an ontology element timestamp 34 associated with each ontology element 24. The ontology element timestamp 34 may indicate a time at which the ML system 2 received the conversational turn 20 from which the ontology element 24 was extracted. The ontology index 30 may also store a respective ontology element embedding 36 associated with each of the ontology elements 24. The ontology element embedding 36 may be used to perform RAG in examples in which structured retrieval fails, as discussed below. Other metadata associated with the ontology elements 24 may also be stored in the ontology index 30 in some examples.

In some examples, the ontology elements 24 and their respective ontology element types 32 are extracted from the plurality of conversational turns 20 in real time during interaction between the user 3 and the ML system 2. In other examples, at least a portion of the ontology elements 24 and ontology element types 32 may be extracted and stored during offline processing performed outside of a user session. In such examples, the one or more processing devices 10 may be configured to perform offline processing to extract additional details from one or more conversational turns 20 on which less-detailed ontology element extraction has already been performed. The one or more processing devices 10 may accordingly be configured to perform real-time retrieval of ontology elements 24 extracted during a user session, while delaying more detailed extraction that could lead to high latency in response generation.

In some examples, the one or more processing devices 10 are further configured to extract ontology elements 24 and ontology element types 32 from interactions in which a plurality of conversational turns 20 are exchanged between multiple users but not with the generative language model 22. For example, the one or more processing devices 10 may be further configured to perform ontology element extraction on meeting transcripts, email threads, or chat logs in which the generative language model 22 is not a participant.

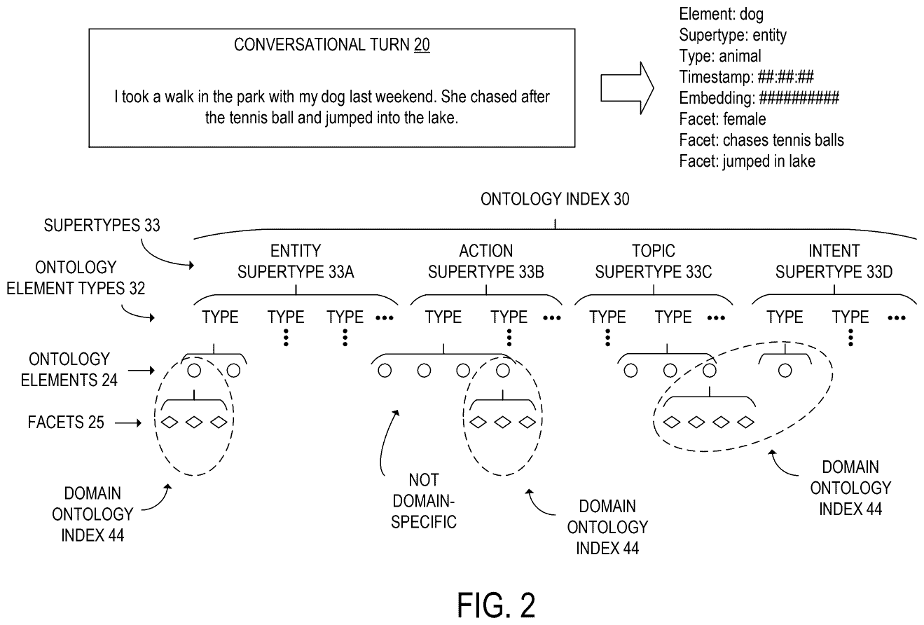

FIG. 2 schematically shows an example ontology index 30. Within the ontology index 30, the ontology elements 24 are organized according to their ontology element types 32. For example, the ontology index 30 may have a hierarchical structure. In this hierarchical structure, the ontology elements 24 at a first level of the ontology index 30 are indicated as facets 25 of respective ontology elements 24 at a second level. The facets 25, in such examples, are ontology elements 24 that provide additional details related to the ontology elements 24 below which they are located in the hierarchical structure. For example, the ontology element “flower” may have a facet “purple” and a facet “perennial.”

The ontology index 30 may include three or more levels in some examples. For example, the hierarchical structure of the ontology index 30 may include a plurality of supertypes 33 assigned to the ontology elements 24. The plurality of supertypes 33 may include an entity supertype, an action supertype, and a topic supertype. The plurality of supertypes 33 also include an intent supertype in the example of FIG. 2. These supertypes 33 organize the ontology elements 24 into overarching categories that indicate roles of those ontology elements 24 in the conversation between the user 2 and the ML system 3. For example, when the ML system 3 is an assistant system configured to programmatically take actions such as managing the user's calendar and setting reminders for the user, the action supertype may indicate potential actions that the ML system 3 may perform on systems and objects outside the conversation with the user 2. The one or more processing devices 10 may also be configured to apply the action supertype to other types of actions, such as those performed by the user or by other entities.

In the example of FIG. 2, the one or more processing devices 10 are configured to receive, as a conversational turn 20, a user input stating “I took a walk in the park with my dog last weekend. She chased after the tennis ball and jumped into the lake.” From this input, the one or more processing devices 10 are further configured to extract an ontology element “dog” that has the supertype “entity,” the type “animal,” and the facets “female,” “chases tennis balls,” and “jumped in lake.” The one or more processing devices 10 are also configured to extract an ontology element timestamp 34 and an ontology element embedding 36 of this input.

Returning to FIG. 1, in some examples, the ontology index 30 includes respective domain ontology indices 44 associated with respective domain-specific agents 40. The domain-specific agents 40 are portions of the ML system 2 that are specialized for interactions with the user related to specific topics (e.g., medicine, mathematics, or programming). In some examples, the domain-specific agents 40 are specialized ML models that are included in the ML system 2 along with the generative language model 22. The domain-specific agents 40 may additionally or alternatively include rule-based logic that does not utilize machine learning.

During extraction of the plurality of ontology elements 24 from the plurality of conversational turns 20, the one or more processing devices 10 may be further configured to classify at least a portion of the plurality of ontology elements 24 into respective domains. These domains may be indicated by the ontology element types 32 of the ontology entities. In some examples, the domains associated with the ontology elements 24 are identified at the generative language model 22 when processing the context 23 that includes the entity extraction prompt fragment 26. The plurality of ontology elements 24 that are included in respective domain ontology indices 44 may be grouped into domain memory 42 within the ontology index 30. This grouping may facilitate searching performed during ontology element retrieval in examples in which a domain-specific agent 40 is used when executing a structured RAG query.

In some examples, one or more of the domain ontology indices 44 include respective ontology elements 24 that are obtained from sources other than the conversational turns 20. For example, ontology elements 24 may be loaded into the domain memory 42 from a database or application program outside the ML system 2. In some examples, the generative language model 22 may be used to perform ontology element extraction on that additional data source.

FIG. 1 further shows the retrieval of one or more ontology elements 24 from the ontology index 30 and the use of the one or more retrieved ontology elements 24 to compute an output of the generative language model 22. At step G, the one or more processing devices 10 are further configured to compute a structured retrieval-augmented generation (RAG) query 50. The structured RAG query 50 is computed at the generative language model 22 based at least in part on a user input 20A received at the ML system 2. For example, the generative language model 22 may detect that the user input 20A includes a request for information included in a portion of the conversation that is outside the context 23 of the generative language model 22. The generative language model 22 may be further configured to generate at least a portion of the structured RAG query 50 in response to making this determination.

At step H, the one or more processing devices 10 are further configured to execute the structured RAG query 50 over the ontology index 30. Thus, the one or more processing devices 10 are configured to obtain one or more retrieved ontology elements 24 from the ontology index 30 as a structured RAG query result 52.

In some examples, the one or more processing devices 10 may be configured to execute a query that is not generated with the generative language model 22. For example, a user-written query may be executed. In other examples, the generative language model 22 may be used during query matching (e.g., to perform typo correction or word stemming) without being used to generate the structured RAG query 50.

At step J, the one or more processing devices 10 may be further configured to load the structured RAG query result 52 into working memory 56. The working memory 56 is a data structure that stores one or more ontology elements 24, and optionally metadata associated with the one or more ontology elements 24, that are selected for inclusion in the context 23 of the generative language model 22. In some examples, in addition to the one or more ontology elements 24 retrieved in response to a current user input 20A, one or more ontology elements 24 retrieved in response to at least one other recent user input 20A may also be maintained in the working memory 56. For example, the one or more other ontology elements 24 may be maintained for a predetermined number of conversational turns 20. Thus, the generative language model 22 may continue to use recently retrieved ontology elements 24 in multiple successive rounds of output generation.

At step K, at the generative language model 22, the one or more processing devices 10 are further configured to compute a generative language model output 58 based at least in part on the user input 20A and the one or more retrieved ontology elements 24. When the generative language model output 58 is computed, the context 23 the generative language model 22 includes the one or more retrieved ontology elements 24 and the user input 20A in response to which the structured RAG query 50 was generated. One or more conversational turns 20 prior to that user input 20A may also be included in the context 23.

At step L, the one or more processing devices 10 are further configured to output the generative language model output 58. In the example of FIG. 1, the one or more processing devices 10 are configured to output the generative language model output 58 to the GUI 21 as a conversational turn. The results of the structured RAG query 50 are accordingly presented to the user 3.

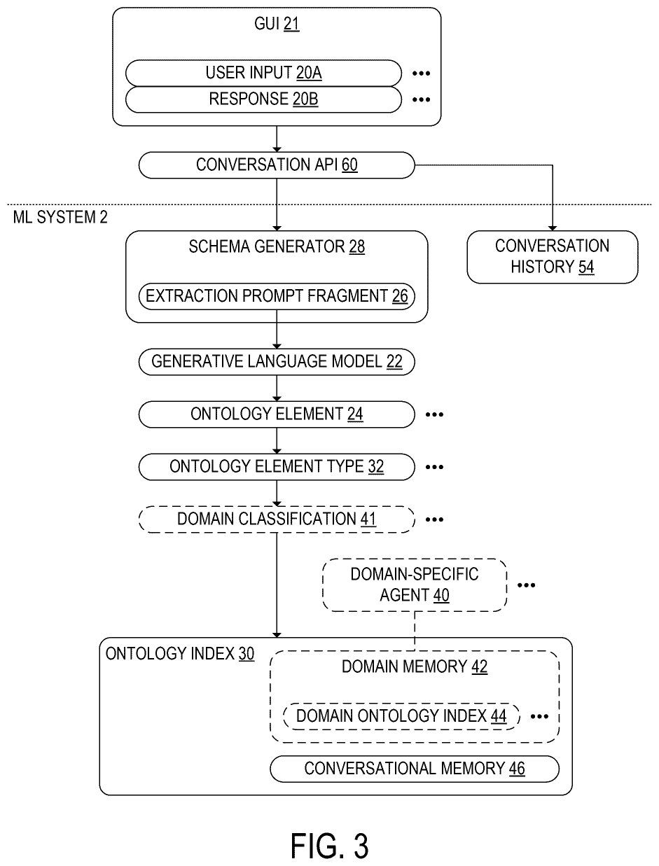

FIG. 3 schematically shows ontology entity extraction and storage in additional detail, according to one example. In the example of FIG. 3, the GUI 21 is configured to interact with components of the ML system 2 over a conversation application-programming interface (API) 60. The conversation API 60 is configured to store the conversation history 54. In addition, the conversation API 60 may be configured to input the conversational turns 20 into a schema generator 28. The schema generation 28 is configured to programmatically compute the extraction prompt fragment 26 that is input into the generative language model 22 to identify the ontology elements 24. For example, TypeChat may be used as the schema generator 28.

In the example of FIG. 3, during extraction of the plurality of ontology elements 24 from the plurality of conversational turns 20, the one or more processing devices 10 are further configured to classify at least a portion of the plurality of ontology elements 24 into respective domains. Accordingly, in the example of FIG. 3, a plurality of domain classifications 41 are extracted in parallel with the ontology elements 24 and the ontology element types 32. This classification is performed at the generative language model 22. For example, the extraction prompt fragment 26 may include instructions for the generative language model 22 to determine whether each of the ontology elements 24 belongs to any of a specified list of domains. The one or more processing devices 10 are further configured to store the classified ontology elements 24 in the respective domain ontology indices 44 of those domains.

An example schema that may be used as the extraction prompt fragment 26 is provided below:

```
export type Quantity = {
  amount: number;
  units: string;
};
export type Value = string | number | boolean | Quantity;
export type Facet = {
  name: string;
  // Very concise values.
  value: Value;
};
// Specific, tangible people, places, institutions or things only
export type ConcreteEntity = {
  // the name of the entity or thing such as “Bach”, “Great Gatsby”, “frog” or “piano”
  name: string;
  // the types of the entity such as “speaker”, “person”, “artist”, “animal”, “object”,
“instrument”, “school”, “room”, “museum”, “food” etc.
  // An entity can have multiple types; entity types should be single words
  type: string[ ];
  // A specific, inherent, defining, or non-immediate facet of the entity such as “blue”,
“old”, “famous”, “sister”, “aunt_of”, “weight: 4 kg”
  // trivial actions or state changes are not facets
  // facets are concise “properties”
  facets?: Facet[ ];
};
export type ActionParam = {
  name: string;
  value: Value;
};
export type VerbTense = “past” | “present” | “future”;
export type Action = {
  // Each verb is typically a word
  verbs: string[ ];
  verbTense: VerbTense;
  subjectEntityName: string | “none”;
  objectEntityName: string | “none”;
  indirectObjectEntityName: string | “none”;
  params?: (string | ActionParam)[ ];
};
// Detailed and comprehensive knowledge response
export type KnowledgeResponse = {
  entities: ConcreteEntity[ ];
  // The ‘subjectEntityName’ and ‘objectEntityName’ must correspond to the ‘name’ of
an entity listed in the ‘entities' array.
  actions: Action[ ];
  // Detailed, descriptive topics and keyword.
  topics: string[ ];
};
```

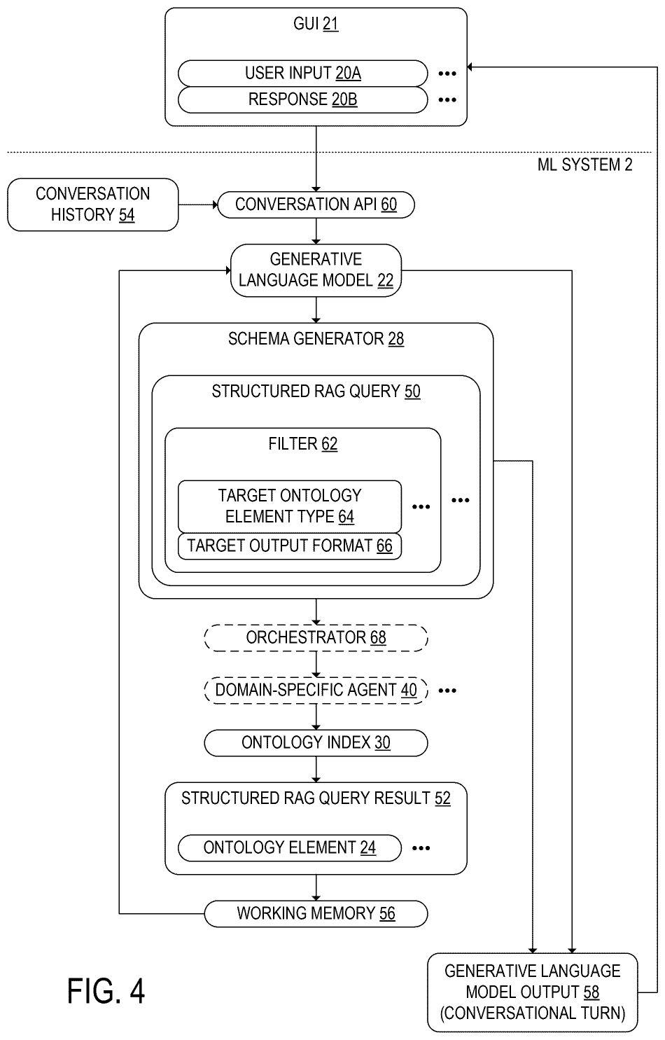

FIG. 4 schematically shows the retrieval of the one or more retrieved ontology elements 24 in additional detail, according to one example. As in the example of FIG. 3, the conversation API 60 is configured to retrieve a user input 20A from the GUI 21. The conversation API 21 is further configured to retrieve at least a portion of the conversation history 54.

In the example of FIG. 4, the one or more processing devices 10 are further configured to execute the schema generator 28 to compute the structured RAG query 50. The structured RAG query 50 includes one or more filters 62 that specify properties of the data retrieved from the ontology index 30. The one or more filters 62 may each include one or more target ontology element types 64 for the one or more retrieved ontology elements 24. A filter 62 may additionally include a target output format 66 in which the one or more retrieved ontology elements 24 are arranged in the generative language model output 58. For example, the target output format 66 may instruct the generative language model 22 to present the one or more retrieved ontology elements 24 in a list of text strings. As another example, the target output format 66 may instruct the generative language model 22 to generate an image that depicts the one or more retrieved ontology elements 24.

In examples in which the ontology index 30 includes a plurality of domain ontology indices 44, the one or more processing devices 10 may be further configured to generate the structured RAG query 50 to include one or more target ontology element types 32 of the one or more retrieved ontology elements 24. During execution of the structured RAG query 50, the one or more processing devices 10 may be further configured to select a domain-specific agent 40 from among the plurality of domain-specific agents 40 based at least in part on the one or more target ontology element types 32. The one or more processing devices 10 may, in such examples, be configured to select the domain-specific agent 40 by executing an orchestrator 68 included in the ML system 2. The orchestrator 68, in such examples, is a module that determines when to selectively activate different ML models and/or other agents included in the ML system 2. For example, the orchestrator 68 may store a respective set of ontology element types 32 associated with each domain-specific agent 40, and may select the domain-specific agent 40 at least in part by determining that the target ontology element type 64 is included in the set of ontology element types 32 associated with that domain-specific agent 40.

Subsequently to identifying the domain-specific agent 40, the one or more processing devices 10 may be further configured to select the one or more retrieved ontology elements 24 at least in part by executing the selected domain-specific agent 40. During execution of the structured RAG query 50, the one or more processing devices 10 may be further configured to obtain at least one of the one or more retrieved ontology elements 24 from the domain ontology index 44 of the selected domain-specific agent 40. The domain-specific agent 40 may select the at least one retrieved ontology element 24 from its domain ontology index 44. Thus, the ML system 2 may utilize the specialized functionality of the domain-specific agent 40 to select the at least one retrieved ontology element 24 in a manner that produces more accurate and relevant selections.

An example of a schema that may be filled to compute the structured RAG query 50 is provided below:

```
import { DateTimeRange } from “./dateTimeSchema.js”;
/*
  A conversation is a sequence of messages between one or more users/speakers and
assistants.
  The message sequence, and any entities/topics in each message are indexed.
  Entity is defined as: Specific, tangible people, places, institutions or things
  Entities and topics can be used to select their source messages
*/
// Use to search based on the topics, concepts, abstractions, feelings.
export type TopicFilter = {
  filterType: “Topic”;
  // Match topics same or similar to this, such as “emotions”, “politics”, “health”, etc.
  topics?: string;
  // Use only if request explicitly asks for time range
  timeRange?: DateTimeRange | undefined; // in this time range
};
// Use to search for specific or generic or tangible entities only mentioned in the user
request
export type EntityFilter = {
  filterType: “Entity”;
  // The name of the entity when user request specifies a particular item or subject (e.g.,
“sandwich”, “Bach”, “frog”).
  name?: string;
  // the types of the entity such as “artist”, “animal, “instrument”, “school”, “room”,
“museum”, “food” etc.
  // an entity can have multiple types; entity types should be single words
  type?: string[ ];
  // Use only if request explicitly asks for time range
  timeRange?: DateTimeRange | undefined; // in this time range
};
export type ActionFilter = {
  filterType: “Action”;
  // Each verb is typically a word
  verbs: string[ ];
  verbTense: “past” | “present” | “future”;
  subjectEntityName?: string;
  objectEntityName?: string;
  indirectObjectEntityName?: string;
};
export type Filter = TopicFilter | EntityFilter | ActionFilter;
// Select this type of data to show the user
export type ResponseType =
  | “Entities” // Show information about matching entities
  | “Entity_Facets” // Show specific facets/facts/attributes of matching entities. E.g.
name, age, interests, profession, quantity, color
  | “Topics” // Show topics or themes of discussion
  | “Answer”; // Show an answer that is derived/inferred from any matched messages,
topics or entities
export type ResponseStyle = “Paragraph” | “List”;
// Used to get answers about:
// - topics of discussion, overviews, “what did we talk about” etc.
// - specific entities, time/date ranges, “when”, “how long” etc.
// - general inquiries where the answer may not be structured or requires interpreting
selected data.
// When a question references topics that may be entities, include both topic & entity
filters
export type GetAnswerAction = {
  actionName: “getAnswer”;
  parameters: {
    // How to filter index
    filters: Filter[ ];
    responseType: ResponseType;
    responseStyle: ResponseStyle;
  };
};
export type UnknownAction = {
  actionName: “unknown”;
};
export type SearchAction = GetAnswerAction | UnknownAction;
```

By using the generative language model 22 to perform ontology element extraction and ontology element type identification, the one or more processing devices 10 are configured to utilize the advanced natural language modeling capabilities of the generative language model 22 to resolve potential ambiguities in the conversational turns 20. For example, when extracting ontology elements 24 and ontology element types 32 from the sentence “I turned out an unsuccessful book a year for about fifteen years,” the generative language model 22 may infer from the contextual information included in the rest of the sentence that the phrase “turned out” means “wrote.” This interpretation of the phrase “turned out” may also have occurred earlier in the conversation or during offline processing and may be reused when extracting ontology elements 24 and ontology elements 32 from the above sentence. The one or more processing devices 10 may be further configured to store an ontology element “write” in the ontology index 30. The ontology index 30, in this example, also stores other ontology elements 24 related to writing.

With previous RAG techniques, “turned out” may have low cosine similarity to “write” and may therefore have a low probability of being retrieved. In contrast, the ontology index 30 may store ontology elements 24 related to the above sentence in the same domain ontology index 44 as other ontology elements 24 related to writing. During retrieval, when the one or more processing devices 10 query the ontology index 30 for information related to writing, the one or more processing devices 10 may retrieve information extracted from the above sentence, whereas such information would not be retrieved with previous RAG techniques.

In some examples, the one or more processing devices 10 may also be configured to fill a schema computed using the schema generator 28 when generating the generative language model output 58 from the one or more retrieved ontology elements 24. An example schema is provided below:

```
export interface Entity {
  // the name of the entity such as “Bach” or “frog”
  name: string;
  // the types of the entity such as “artist” or “animal”; an entity can have multiple
types; entity types should be single words
  type: string[ ];
}
// use this ChatResponseAction if the request should be handled by showing the user a
generated message instead of running an action which will generate a message
// this is the way to handle requests for general chat information like “what is the
weather” or “tell me a joke”
// prefer this action to switching to a different assistant if the request is for general chat
information
// if the request is for contemporary chat information including sports scores, use the
lookups parameter to request a lookup of the information on the user's behalf
export interface ChatResponseAction {
  actionName: “chatResponse”;
  parameters: {
    // the original request from the user
    originalRequest: string;
    // the generated text to show the user; if lookups are used, this text should let the
user know a lookup is in progress
    generatedText: string;
    // all entities present in the user's request
    userRequestEntities: Entity[ ];
    // all entities present in the generated text
    generatedTextEntities: Entity[ ];
    // Lookup *facts* you don't know or if your facts are out of date.
    // E.g. stock prices, time sensitive data, etc
    // the search strings to look up on the user's behalf should be specific enough to
return the correct information
    // it is recommended to include the same entities as in the user request
    lookups?: string[ ];
  };
}
```

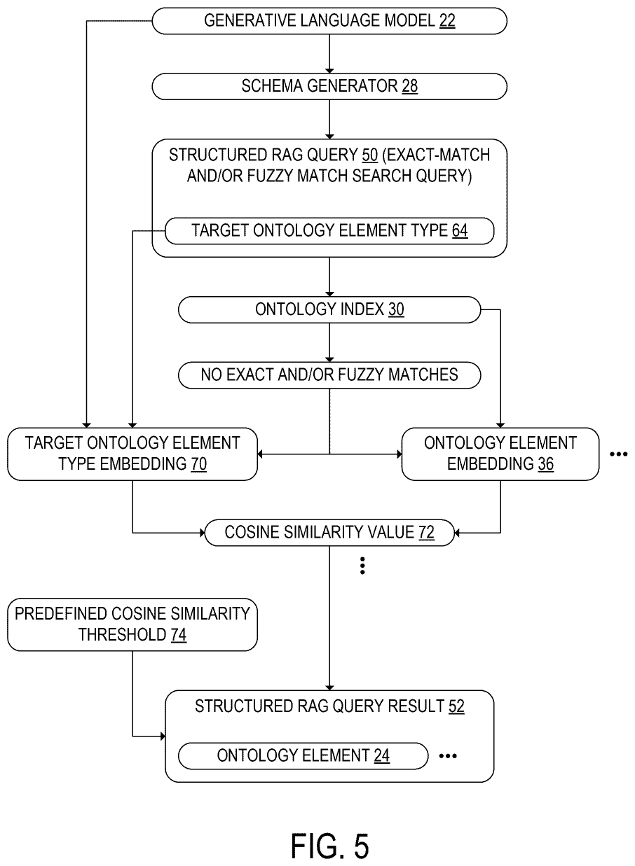

In some examples, the one or more processing devices 10 may be configured to use unstructured RAG in response to structured RAG returning no results. FIG. 5 schematically shows an example in which the structured RAG query 50 is an exact-match search query for one or more of the ontology elements 24 that have a target ontology element type 64. In the example of FIG. 5, the one or more processing devices 10 are further configured to determine that the structured RAG query 50 returns no exact matches to the target ontology element type 64. Thus, the one or more processing devices 10 are further configured to perform unstructured RAG as a backup retrieval technique. In response to determining that the structured RAG query 50 returns no exact matches, the one or more processing devices 10 are further configured to compute a plurality of cosine similarity values 72 between respective embeddings 70 and 36 of the target ontology element type 64 and respective ontology elements 24 stored in the ontology index 30. In such examples, the target ontology element type embedding 70 may be computed at the generative language model 22 when the structured RAG query 50 is generated. The one or more processing devices 10 are further configured to select, as the one or more retrieved ontology elements 24, one or more of the ontology elements 24 that have cosine similarity values 72 above a predefined cosine similarity threshold 74. The one or more processing devices 10 are accordingly configured to identify an approximate match to the target ontology element type 64 when no exact match is returned.

In some examples, one or more fuzzy matching techniques other than unstructured RAG may additionally or alternatively be used during ontology element retrieval when no exact match to the structured RAG query 50 occurs in the ontology index 30. For example, minimum edit distance may be used to perform matching between the structured RAG query 50 and the ontology elements 24. By selecting the one or more retrieved ontology elements 24 based at least in part on their respective minimum edit distances from the name or type of at least one ontology element 24 specified in the structured RAG query 50, the one or more processing devices 10 may be configured to account for typos in the structured RAG query 50. In some examples, the one or more additional fuzzy matching techniques are used as an intermediate stage between exact matching and unstructured RAG to narrow down the set of ontology elements 24 over which the cosine similarity search is performed. In some examples, the generative language model 22 may be used in fuzzy matching to perform operations such as typo correction or word stemming.

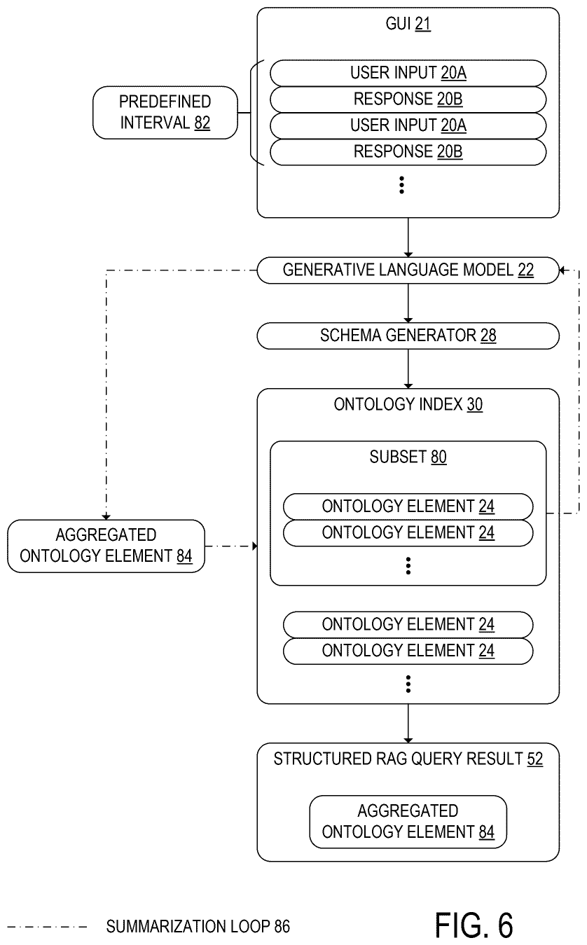

FIG. 6 schematically shows an example in which the one or more processing devices 10 are further configured to summarize a portion of the conversation between the user 3 and the ML system 2. In the example of FIG. 6, the one or more processing devices 10 are further configured to compute an aggregated ontology element 84 at the generative language model 22. The aggregated ontology element 84 is computed based at least in part on a subset 80 of the plurality of ontology elements 24 extracted from the conversational turns 20 included in the conversation. For example, the one or more processing devices 10 may be configured to generate a corresponding aggregated ontology element 84 at a predefined interval 82. The predefined interval 82 may, for example, be a predefined number of conversational turns 20 or a predefined number of extracted ontology elements 24. The aggregated ontology element 84 summarizes ontology elements 24 included in the subset 80, for example by identifying a higher-level topic for those ontology elements 24 in the hierarchical structure of the ontology index 30.

The one or more processing devices 10 are further configured to store the aggregated ontology element 84 in the ontology index 30. During execution of the structured RAG query 50, the one or more processing devices 10 are further configured to retrieve the aggregated ontology element 84 from the ontology index 30 for inclusion in the structured RAG query result 52. In the example of FIG. 6, the one or more processing devices 10 are configured to execute a summarization loop 86 in which, at the predefined interval 82, the one or more processing devices 10 iteratively aggregate respective subsets 80 of the ontology index 30 and store the resulting aggregated ontology elements 84 in the ontology index. Iteratively summarizing the ontology elements 24 by executing the summarization loop 86 may allow the ML system 2 to more accurately recall high-level features of its interactions with the user 3, such as topics or entities that occur in the conversational turns 20.

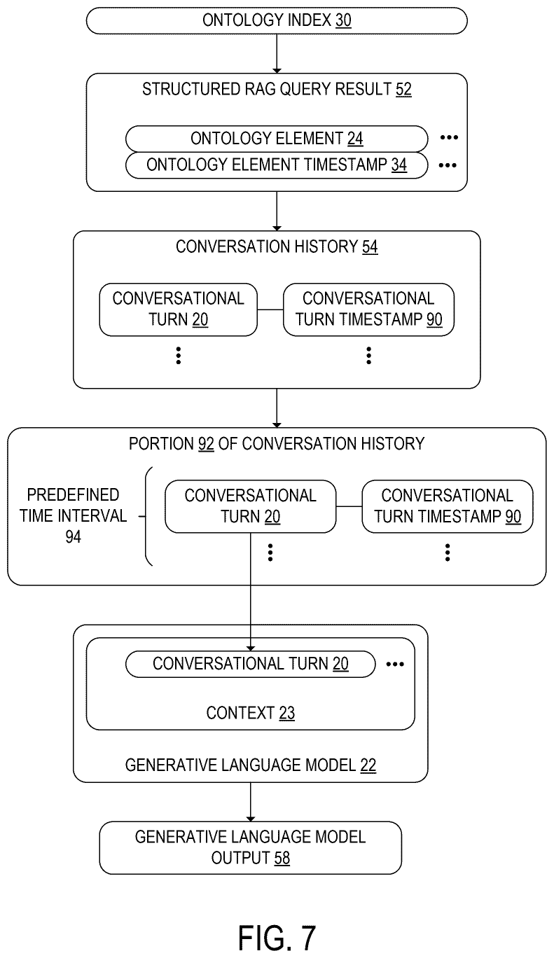

FIG. 7 schematically shows an example in which the one or more processing devices 10 are further configured to utilize the ontology index 30 to retrieve a portion 92 of the conversation history 54. In such examples, when computing the context 23 of the generative language model 22, the one or more processing devices 10 are further configured to refer to the respective ontology element timestamps 34 of the one or more retrieved ontology elements 24. The conversational turns 20 stored in the conversation history 54 also have respective conversational turn timestamps 90 in the example of FIG. 7.

According to the example of FIG. 7, the one or more processing devices 10 are further configured to compute the generative language model output 58 at least in part by, for each of the one or more retrieved ontology elements 24, inputting a respective portion 92 of the conversation history 54 into the context 23 of the generative language model 22. This portion 92 may be a portion of the conversation history 54 located within a predefined time interval 94 of the ontology element timestamp 34 of that retrieved ontology element 24. In other examples, the portion 92 may include the conversational turns 20 location within a predefined number of conversational turns 20 from the ontology element timestamp 34. In other examples, only the conversational turn 20 from which the retrieved ontology element 24 was extracted may be loaded into the context 23.

By using one or more conversational turns 20 proximate to the retrieved ontology element 24 as input to the generative language model 22, the one or more processing devices 10 may base the generative language model output 58 on the exact input from which the one or more retrieved ontology elements 24 are extracted, rather than on a summary of that input. Loading the portion 92 of the conversation history 54 into the context 23 may accordingly increase the relevance and accuracy of the generative language model output 58.

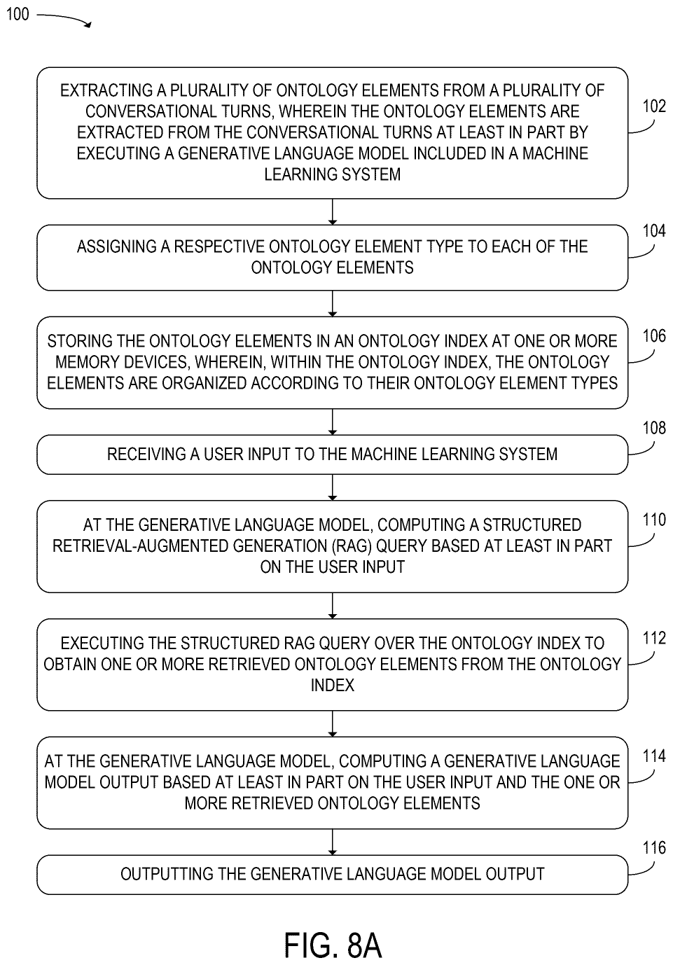

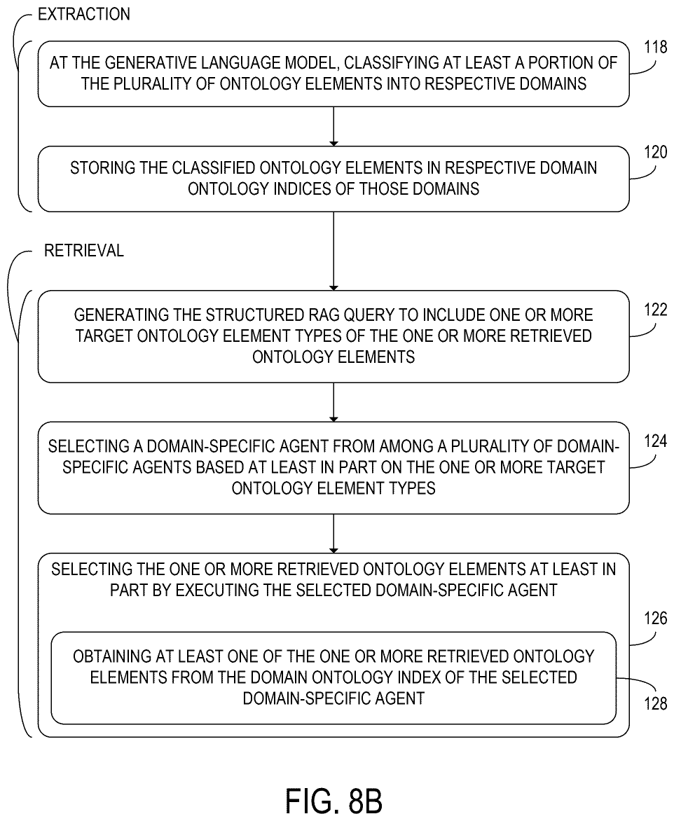

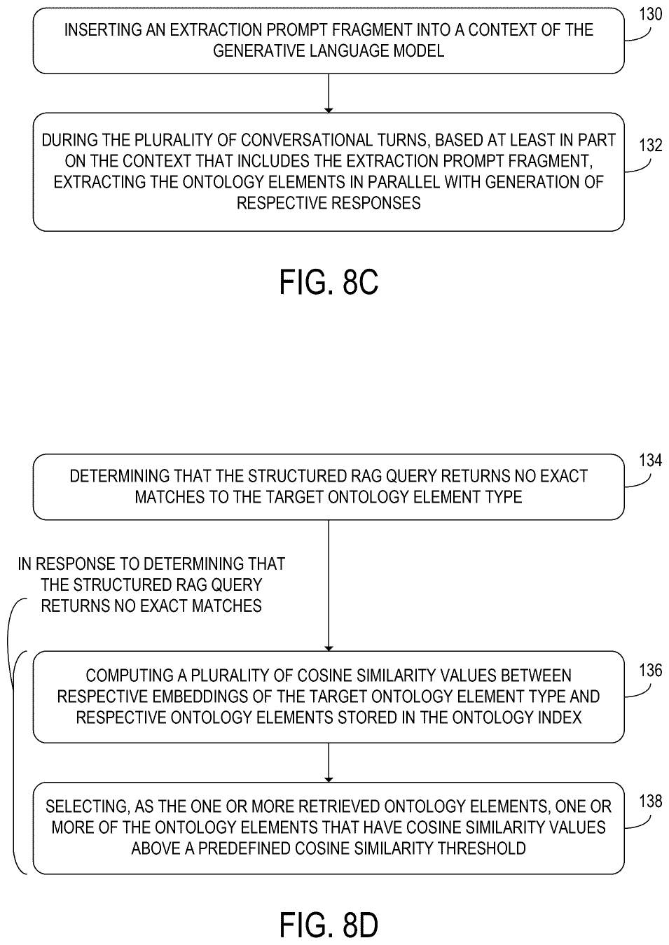

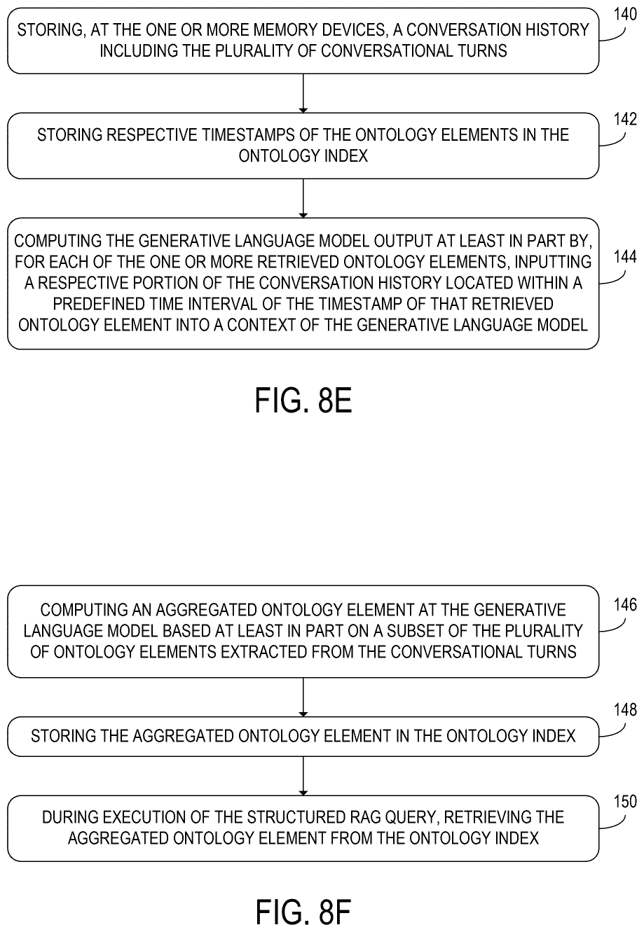

FIG. 8A shows a flowchart of a method 100 for use with a computing system to perform structured RAG. At step 102, the method 100 includes extracting a plurality of ontology elements from a plurality of conversational turns. The conversational turns may be interactions between the one or more users and the ML system at a GUI or other user interface. In some examples, ontology elements may additionally or alternatively be extracted from conversations that include conversational turns between users but not with the ML system. The ontology elements are extracted from the conversational turns at least in part by executing a generative language model included in the ML system. Accordingly, the ML system is configured to use the generative language model to extract ontology elements that indicate semantic content included in the conversational turns.

At step 104, the method 100 further includes assigning a respective ontology element type to each of the ontology elements. The ontology element types may also be computed at the generative language model and may be computed in the same inferencing pass in which the ontology elements are extracted. In some examples, the ontology elements may be assigned a respective plurality of supertypes that indicate groupings of the ontology element types. For example, the plurality of supertypes may include an entity supertype, an action supertype, a topic supertype, and an intent supertype.

At step 106, the method 100 further includes storing the ontology elements in an ontology index at one or more memory devices. Within the ontology index, the ontology elements are organized according to their ontology element types. The ontology index may have a hierarchical structure within which the ontology elements are organized according to their supertypes. Additionally or alternatively, the ontology elements at a first level of the hierarchical structure may be indicated as facets of respective ontology elements located at a second level. The facets, in such examples, are ontology elements that provide additional details related to the corresponding ontology elements located above the facets in the hierarchical structure.

Subsequently to ontology element extraction and storage, the ontology elements are used to generate outputs of the ML system. At step 108, the method 100 further includes receiving a user input to the ML system. The user input may be received at the user interface as a conversational turn.

At step 110, the method 100 further includes computing a structured RAG query at the generative language model based at least in part on the user input. The structured RAG query is a query to the ontology entity index for one or more ontology entities. The structured RAG query may, for example, include one or more filters that specify respective target ontology element types. The one or more filters may also include respective target output formats.

At step 112, the method 100 further includes executing the structured RAG query over the ontology index to obtain one or more retrieved ontology elements from the ontology index. The one or more retrieved ontology elements are included in a structured RAG query result that may be loaded into working memory of the ML system.

At step 114, the method further includes, at the generative language model, computing a generative language model output based at least in part on the user input and the one or more retrieved ontology elements. The user input and the one or more retrieved ontology elements may be loaded into a context of the generative language model and used to autoregressively generated the generative language model output. At step 116, the method 100 further includes outputting the generative language model output. The generative language model output may be output to the user interface as a conversational turn.

FIG. 8B shows additional steps of the method 100 that may be performed in some examples. Steps 118 and 120, as shown in FIG. 8B may be performed during extraction of the one or more ontology elements, whereas steps 122, 124, 126, and 128 may be performed during retrieval. At step 118, the method 100 may further include, at the generative language model, classifying at least a portion of the plurality of ontology elements into respective domains. The domains are areas of specialization associated with domain-specific agents included in the ML system.

At step 120, the method 100 may further include storing the classified ontology elements in respective domain ontology indices of those domains. Accordingly, in the example of FIG. 8B, the ontology index includes the domain ontology indices as sub-indices. In some examples, the domain ontology indices may further include one or more ontology elements extracted from sources other than conversational turns.

At step 122, the method 100 may further include generating the structured RAG query to include one or more target ontology element types of the one or more retrieved ontology elements. As discussed above, the one or more target ontology element types may be specified in respective filters.

At step 124, during execution of the structured RAG query, the method 100 may further include selecting a domain-specific agent from among a plurality of domain-specific agents based at least in part on the one or more target ontology element types. For example, the one or more memory devices may store a respective set of ontology element types associated with each of the domain-specific agents, and the domain-specific agent may be selected at step 124 by determining that the target ontology element type is within the set of associated ontology element types for that domain-specific agent.

At step 126, the method 100 may further include selecting the one or more retrieved ontology elements at least in part by executing the selected domain-specific agent. For example, the domain-specific agent may be a specialized ML model. The domain-specific agent may additionally or alternatively utilize rule-based programming logic to select the one or more retrieved ontology elements. At step 128, step 126 may include obtaining at least one of the one or more retrieved ontology elements from the domain ontology index of the selected domain-specific agent. Thus, the ML system may retrieve an ontology element that is relevant to the domain of the selected domain-specific agent.

FIG. 8C shows additional steps of the method 100 that may be performed during ontology element extraction. At step 130, the method 100 may further include inserting an extraction prompt fragment into a context of the generative language model. The extraction prompt fragment may, for example, be a schema computed at a schema generator. In such examples, the schema may be used as a template that is filled via autoregressive generation at the generative language model.

At step 132, the method 100 may further include extracting the ontology elements in parallel with generation of respective responses during the plurality of conversational turns. The ontology elements are extracted based at least in part on the context that includes the extraction prompt fragment. By extracting the ontology elements in parallel with response generation, the number of calls to the generative language model may be reduced, thereby decreasing the latency associated with generating the responses and extracting the ontology elements.

FIG. 8D shows additional steps of the method 100 that may be performed during retrieval in examples in which the structured RAG query is an exact-match search query for one or more of the ontology elements that have a target ontology element type. At step 134, the method 100 may further include determining that the structured RAG query returns no exact matches to the target ontology element type.

At step 136, in response to determining that the structured RAG query returns no exact matches, the method 100 may further include computing a plurality of cosine similarity values between respective embeddings of the target ontology element type and respective ontology elements stored in the ontology index. At step 138, the method 100 may further include selecting, as the one or more retrieved ontology elements, one or more of the ontology elements that have cosine similarity values above a predefined cosine similarity threshold. Accordingly, the ML system may perform unstructured RAG as a backup technique when no exact match is found. In some examples, one or more other fuzzy matching techniques may be performed instead of unstructured RAG or in an intermediate stage between the exact-match search and unstructured RAG.

FIG. 8E shows additional steps of the method 100 that may be performed in some examples. At step 140, the method 100 may further include storing, at the one or more memory devices, a conversation history including the plurality of conversational turns. The conversational turns may be stored along with respective timestamps. In addition, at step 142, the method 100 may further include storing respective timestamps of the ontology elements in the ontology index.

At step 144, the method 100 may further include computing the generative language model output at least in part by, for each of the one or more retrieved ontology elements, inputting a respective portion of the conversation history located within a predefined time interval of the timestamp of that retrieved ontology element into the context of the generative language model. The conversational turn from which the retrieved ontology element was extracted may accordingly be inserted into the context. One or more adjacent conversational turns may also be inserted into the context in some examples.

FIG. 8F shows additional steps of the method 100 that may be performed in some examples. At step 146, the method 100 may further include computing an aggregated ontology element at the generative language model based at least in part on a subset of the plurality of ontology elements extracted from the conversational turns. For example, the aggregated ontology element may summarize one or more topics of the ontology elements included in the subset. An aggregated ontology element may, for example, be extracted at a predefined interval expressed as a predefined number of conversational turns or extracted ontology elements. At step 148, the method 100 may further include storing the aggregated ontology element in the ontology index.

At step 150, during execution of the structured RAG query, the method 100 may further include retrieving the aggregated ontology element from the ontology index. A summary of the ontology elements included in the subset may accordingly be used when generating the generative language model output.

Using the systems and methods discussed above, structured RAG may be performed in order to incorporate retrieved information when generating response to user input at an ML system. In contrast to existing RAG approaches in which such information is stored in an unstructured vector database, structured RAG utilizes an ontology index to organize extracted ontology elements. This ontology index allows the relationships between different ontology elements to be specified in a more detailed manner than in the vector databases used in existing RAG techniques. Structured RAG may therefore allow the ML system to retrieve data that is more likely to be relevant to a user's request. Structured RAG also allows for exact retrieval of stored ontology elements, in contrast to the approximate retrieval used in unstructured RAG. Structured may therefore have a lower error rate than unstructured RAG, in terms of both false positives and false negatives. In addition, structured RAG utilizes the natural language modeling capabilities of a generative language model for ontology element extraction and ontology index query generation. By using a generative language model for these tasks, structured RAG may capture the semantic features of stored and retrieved data more accurately than the vector encoding models used in unstructured RAG. Structured RAG may also use the generative language model to achieve greater flexibility in the contents and structures of ontology index queries and generated responses compared to systems that use ontology databases without ML models. In addition, the techniques discussed above ontologies to be programmatically constructed and scaled up without requiring human curation.

The methods and processes described herein are tied to a computing system of one or more computing devices. In particular, such methods and processes can be implemented as a computer-application program or service, an application-programming interface (API), a library, and/or other computer-program product.

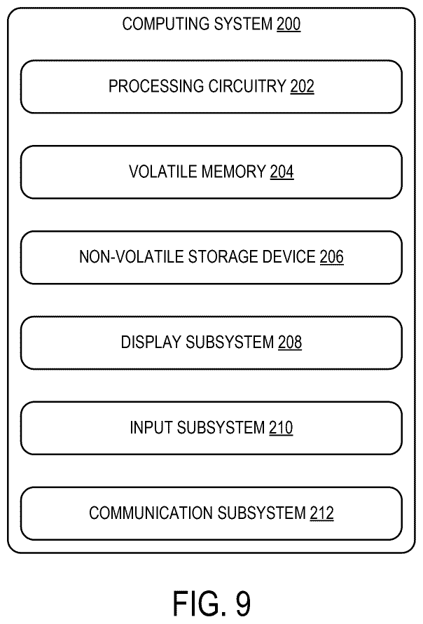

FIG. 9 schematically shows a non-limiting embodiment of a computing system 200 that can enact one or more of the methods and processes described above. Computing system 200 is shown in simplified form. Computing system 200 may embody the computing system 1 described above and illustrated in FIG. 1. Components of computing system 200 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 200 includes processing circuitry 202, volatile memory 204, and a non-volatile storage device 206. Computing system 200 may optionally include a display subsystem 208, input subsystem 210, communication subsystem 212, and/or other components not shown in FIG. 9.

Processing circuitry 202 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 202 may be single-core or multi-core, and the instructions executed thereon may be configured for sequential, parallel, and/or distributed processing. Individual components of the processing circuitry 202 optionally may be distributed among two or more separate devices, which may be remotely located and/or configured for coordinated processing. For example, aspects of the computing system 200 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 202.

Non-volatile storage device 206 includes one or more physical devices configured to hold instructions executable by the processing circuitry to implement the methods and processes described herein. When such methods and processes are implemented, the state of non-volatile storage device 206 may be transformed—e.g., to hold different data.

Non-volatile storage device 206 may include physical devices that are removable and/or built in. Non-volatile storage device 206 may include optical memory, semiconductor memory, and/or magnetic memory, or other mass storage device technology. Non-volatile storage device 206 may include nonvolatile, dynamic, static, read/write, read-only, sequential-access, location-addressable, file-addressable, and/or content-addressable devices. It will be appreciated that non-volatile storage device 206 is configured to hold instructions even when power is cut to the non-volatile storage device 206.

Volatile memory 204 may include physical devices that include random access memory. Volatile memory 204 is typically utilized by processing circuitry 202 to temporarily store information during processing of software instructions. It will be appreciated that volatile memory 204 typically does not continue to store instructions when power is cut to the volatile memory 204.

Aspects of processing circuitry 202, volatile memory 204, and non-volatile storage device 206 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 200 typically implemented in software by a processor to perform a particular function using portions of volatile memory 204, which function involves transformative processing that specially configures the processor to perform the function. Thus, a module, program, or engine may be instantiated via processing circuitry 202 executing instructions held by non-volatile storage device 206, using portions of volatile memory 204. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 208 may be used to present a visual representation of data held by non-volatile storage device 206. The visual representation may take the form of a graphical user interface (GUI). As the herein described methods and processes change the data held by the non-volatile storage device, and thus transform the state of the non-volatile storage device, the state of display subsystem 208 may likewise be transformed to visually represent changes in the underlying data. Display subsystem 208 may include one or more display devices utilizing virtually any type of technology. Such display devices may be combined with processing circuitry 202, volatile memory 204, and/or non-volatile storage device 206 in a shared enclosure, or such display devices may be peripheral display devices.

When included, input subsystem 210 may comprise or interface with one or more user-input devices such as a keyboard, mouse, touch screen, camera, or microphone.

When included, communication subsystem 212 may be configured to communicatively couple various computing devices described herein with each other, and with other devices. Communication subsystem 212 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 200 to send and/or receive messages to and/or from other devices via a network such as the Internet.

The following paragraphs discuss several aspects of the present disclosure. According to one aspect of the present disclosure, a computing system is provided, including one or more processing devices configured to extract a plurality of ontology elements from a plurality of conversational turns. The ontology elements are extracted from the conversational turns at least in part by executing a generative language model included in a machine learning system. The one or more processing devices are further configured to assign a respective ontology element type to each of the ontology elements. The one or more processing devices are further configured to store the ontology elements in an ontology index at one or more memory devices. Within the ontology index, the ontology elements are organized according to their ontology element types. The one or more processing devices are further configured to receive a user input to the machine learning system. At the generative language model, the one or more processing devices are further configured to compute a structured retrieval-augmented generation (RAG) query based at least in part on the user input. The one or more processing devices are further configured to execute the structured RAG query over the ontology index to obtain one or more retrieved ontology elements from the ontology index. At the generative language model, the one or more processing devices are further configured to compute a generative language model output based at least in part on the user input and the one or more retrieved ontology elements. The one or more processing devices are further configured to output the generative language model output. The above features may have the technical effect of storing semantic information related to the conversational turns and retrieving that semantic information in a precise manner.

According to this aspect, the one or more processing devices may be further configured to generate the structured RAG query to include one or more target ontology element types of the one or more retrieved ontology elements. During execution of the structured RAG query, the one or more processing devices may be further configured to select a domain-specific agent from among a plurality of domain-specific agents based at least in part on the one or more target ontology element types. The one or more processing devices may be further configured to select the one or more retrieved ontology elements at least in part by executing the selected domain-specific agent. The above features may have the technical effect of utilizing the specialized semantic modeling capabilities of the domain-specific agent to select the one or more retrieved ontology elements.

According to this aspect, the ontology index may include respective domain ontology indices associated with the domain-specific agents. During execution of the structured RAG query, the one or more processing devices may be configured to obtain at least one of the one or more retrieved ontology elements from the domain ontology index of the selected domain-specific agent. The above features may have the technical effect of structuring the ontology index according to the domain specializations of the domain-specific agents, which may facilitate ontology element retrieval.

According to this aspect, during extraction of the plurality of ontology elements from the plurality of conversational turns, the one or more processing devices may be further configured to classify at least a portion of the plurality of ontology elements into respective domains at the generative language model. The one or more processing devices may be further configured to store the classified ontology elements in the respective domain ontology indices of those domains. The above features may have the technical effect of organizing the ontology elements by domain during ontology element extraction.

According to this aspect, the structured RAG query may be an exact-match search query for one or more of the ontology elements that have a target ontology element type. The above features may have the technical effect of retrieving one or more ontology elements that are exact matches to the structured RAG query.

According to this aspect, the one or more processing devices may be further configured to determine that the structured RAG query returns no exact matches to the target ontology element type. In response to determining that the structured RAG query returns no exact matches, the one or more processing devices may be further configured to compute a plurality of cosine similarity values between respective embeddings of the target ontology element type and respective ontology elements stored in the ontology index. The one or more processing devices may be further configured to select, as the one or more retrieved ontology elements, one or more of the ontology elements that have cosine similarity values above a predefined cosine similarity threshold. The above features may have the technical effect of using unstructured RAG as a backup search technique when the one or more processing devices find no exact matches to the target ontology element type.

According to this aspect, the one or more processing devices may be further configured to store, at the one or more memory devices, a conversation history including the plurality of conversational turns. The one or more processing devices may be further configured to store respective timestamps of the ontology elements in the ontology index. The one or more processing devices may be further configured to compute the generative language model output at least in part by, for each of the one or more retrieved ontology elements, inputting a respective portion of the conversation history located within a predefined time interval of the timestamp of that retrieved ontology element into a context of the generative language model. The above features may have the technical effect of retrieving, for use as input to the generative language model, the exact conversational turns proximate to a time at which the one or more retrieved ontology elements occurred in the conversation.

According to this aspect, the one or more processing devices may be further configured to extract the ontology elements from the conversational turns at least in part by inserting an extraction prompt fragment into a context of the generative language model. During the plurality of conversational turns, based at least in part on the context that includes the extraction prompt fragment, the one or more processing devices may be further configured to extract the ontology elements in parallel with generation of respective responses. The above features may have the technical effect of reducing the number of calls to the generative language model that are performed during ontology element extraction.

According to this aspect, the ontology index may have a hierarchical structure in which the ontology elements at a first level are indicated as facets of respective ontology elements at a second level. The above features may have the technical effect of storing, in the ontology index, additional details related to higher-level ontology elements.

According to this aspect, the hierarchical structure of the ontology index may include a plurality of supertypes assigned to the ontology elements. The plurality of supertypes may include an entity supertype, an action supertype, and a topic supertype. The above features may have the technical effect of organizing the ontology elements into overarching categories that indicate the roles of those ontology elements in the conversational turns.

According to this aspect, the one or more processing devices may be further configured to compute an aggregated ontology element at the generative language model based at least in part on a subset of the plurality of ontology elements extracted from the conversational turns. The one or more processing devices may be further configured to store the aggregated ontology element in the ontology index. During execution of the structured RAG query, the one or more processing devices may be further configured to retrieve the aggregated ontology element from the ontology index. The above features may have the technical effect of summarizing previously extracted ontology elements and referring to that summary during ontology element retrieval.

According to another aspect of the present disclosure, a method for use with a computing system is provided. The method includes extracting a plurality of ontology elements from a plurality of conversational turns. The ontology elements are extracted from the conversational turns at least in part by executing a generative language model included in a machine learning system. The method further includes assigning a respective ontology element type to each of the ontology elements. The method further includes storing the ontology elements in an ontology index at one or more memory devices. Within the ontology index, the ontology elements are organized according to their ontology element types. The method further includes receiving a user input to the machine learning system. At the generative language model, the method further includes computing a structured retrieval-augmented generation (RAG) query based at least in part on the user input. The method further includes executing the structured RAG query over the ontology index to obtain one or more retrieved ontology elements from the ontology index. At the generative language model, the method further includes computing a generative language model output based at least in part on the user input and the one or more retrieved ontology elements. The method further includes outputting the generative language model output. The above features may have the technical effect of storing semantic information related to the conversational turns and retrieving that semantic information in a precise manner.

According to this aspect, the method may further include generating the structured RAG query to include one or more target ontology element types of the one or more retrieved ontology elements. During execution of the structured RAG query, the method may further include selecting a domain-specific agent from among a plurality of domain-specific agents based at least in part on the one or more target ontology element types. The method may further include selecting the one or more retrieved ontology elements at least in part by executing the selected domain-specific agent. The above features may have the technical effect of utilizing the specialized semantic modeling capabilities of the domain-specific agent to select the one or more retrieved ontology elements.

According to this aspect, the ontology index may include respective domain ontology indices associated with the domain-specific agents. During execution of the structured RAG query, at least one of the one or more retrieved ontology elements may be obtained from the domain ontology index of the selected domain-specific agent. The above features may have the technical effect of structuring the ontology index according to the domain specializations of the domain-specific agents, which may facilitate ontology element retrieval.

According to this aspect, during extraction of the plurality of ontology elements from the plurality of conversational turns, the method may further include classifying at least a portion of the plurality of ontology elements into respective domains at the generative language model. The method may further include storing the classified ontology elements in the respective domain ontology indices of those domains. The above features may have the technical effect of organizing the ontology elements by domain during ontology element extraction.

According to this aspect, the structured RAG query may be an exact-match search query for one or more of the ontology elements that have a target ontology element type. The above features may have the technical effect of retrieving one or more ontology elements that are exact matches to the structured RAG query.

According to this aspect, the method may further include determining that the structured RAG query returns no exact matches to the target ontology element type. In response to determining that the structured RAG query returns no exact matches, the method may further include computing a plurality of cosine similarity values between respective embeddings of the target ontology element type and respective ontology elements stored in the ontology index. The method may further include selecting, as the one or more retrieved ontology elements, one or more of the ontology elements that have cosine similarity values above a predefined cosine similarity threshold. The above features may have the technical effect of using unstructured RAG as a backup search technique when the one or more processing devices find no exact matches to the target ontology element type.

According to this aspect, extracting the ontology elements from the conversational turns may include inserting an extraction prompt fragment into a context of the generative language model. During the plurality of conversational turns, based at least in part on the context that includes the extraction prompt fragment, the method may further include extracting the ontology elements in parallel with generation of respective responses. The above features may have the technical effect of reducing the number of calls to the generative language model that are performed during ontology element extraction.

According to this aspect, the ontology index may have a hierarchical structure in which the ontology elements at a first level are indicated as facets of respective ontology elements at a second level. The above features may have the technical effect of storing, in the ontology index, additional details related to higher-level ontology elements.

According to another aspect of the present disclosure, a computing system is provided, including one or more memory devices storing an ontology index. Within the ontology index, a plurality of ontology elements are organized according to respective ontology element types. The ontology index includes respective domain ontology indices associated with a plurality of domain-specific agents. The computing system further includes one or more processing devices configured to receive a user input to the machine learning system. At the generative language model, the one or more processing devices are further configured to compute a structured retrieval-augmented generation (RAG) query based at least in part on the user input. The structured RAG query includes one or more target ontology element types. The one or more processing devices are further configured to execute the structured RAG query over the ontology index to obtain, from the ontology one or more retrieved ontology elements that respectively have the one or more target ontology element types. Executing the structured RAG query includes selecting a domain-specific agent from among a plurality of domain-specific agents based at least in part on the one or more target ontology element types. Executing the structured RAG query further includes selecting the one or more retrieved ontology elements at least in part by executing the selected domain-specific agent. At the generative language model, the one or more processing devices are further configured to compute a generative language model output based at least in part on the user input and the one or more retrieved ontology elements. The one or more processing devices are further configured to output the generative language model output. The above features may have the technical effect of retrieving domain-specific data from an ontology index using a programmatically generated query.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processing devices configured to:
extract a plurality of ontology elements from a plurality of conversational turns, wherein the ontology elements are extracted from the conversational turns at least in part by executing a generative language model included in a machine learning system;
assign a respective ontology element type to each of the ontology elements;
store the ontology elements in an ontology index at one or more memory devices, wherein, within the ontology index, the ontology elements are organized according to their ontology element types;
receive a user input to the machine learning system;
at the generative language model, compute a structured retrieval-augmented generation (RAG) query based at least in part on the user input;
execute the structured RAG query over the ontology index to obtain one or more retrieved ontology elements from the ontology index;
at the generative language model, compute a generative language model output based at least in part on the user input and the one or more retrieved ontology elements; and
output the generative language model output.

2. The computing system of claim 1, wherein the one or more processing devices are further configured to:
generate the structured RAG query to include one or more target ontology element types of the one or more retrieved ontology elements; and
during execution of the structured RAG query:
select a domain-specific agent from among a plurality of domain-specific agents based at least in part on the one or more target ontology element types; and
select the one or more retrieved ontology elements at least in part by executing the selected domain-specific agent.

3. The computing system of claim 2, wherein:
the ontology index includes respective domain ontology indices associated with the domain-specific agents; and
during execution of the structured RAG query, the one or more processing devices are configured to obtain at least one of the one or more retrieved ontology elements from the domain ontology index of the selected domain-specific agent.

4. The computing system of claim 3, wherein, during extraction of the plurality of ontology elements from the plurality of conversational turns, the one or more processing devices are further configured to:
at the generative language model, classify at least a portion of the plurality of ontology elements into respective domains;
store the classified ontology elements in the respective domain ontology indices of those domains.

5. The computing system of claim 1, wherein the structured RAG query is an exact-match search query for one or more of the ontology elements that have a target ontology element type.

6. The computing system of claim 5, wherein the one or more processing devices are further configured to:
determine that the structured RAG query returns no exact matches to the target ontology element type; and
in response to determining that the structured RAG query returns no exact matches:
compute a plurality of cosine similarity values between respective embeddings of:
the target ontology element type; and
respective ontology elements stored in the ontology index; and
select, as the one or more retrieved ontology elements, one or more of the ontology elements that have cosine similarity values above a predefined cosine similarity threshold.

7. The computing system of claim 1, wherein the one or more processing devices are further configured to:
store, at the one or more memory devices, a conversation history including the plurality of conversational turns;
store respective timestamps of the ontology elements in the ontology index; and
compute the generative language model output at least in part by, for each of the one or more retrieved ontology elements, inputting a respective portion of the conversation history located within a predefined time interval of the timestamp of that retrieved ontology element into a context of the generative language model.

8. The computing system of claim 1, wherein the one or more processing devices are further configured to extract the ontology elements from the conversational turns at least in part by:
inserting an extraction prompt fragment into a context of the generative language model; and
during the plurality of conversational turns, based at least in part on the context that includes the extraction prompt fragment, extracting the ontology elements in parallel with generation of respective responses.

9. The computing system of claim 1, wherein the ontology index has a hierarchical structure in which the ontology elements at a first level are indicated as facets of respective ontology elements at a second level.

10. The computing system of claim 9, wherein:
the hierarchical structure of the ontology index includes a plurality of supertypes assigned to the ontology elements; and
the plurality of supertypes include an entity supertype, an action supertype, and a topic supertype.

11. The computing system of claim 1, wherein the one or more processing devices are further configured to:
compute an aggregated ontology element at the generative language model based at least in part on a subset of the plurality of ontology elements extracted from the conversational turns;
store the aggregated ontology element in the ontology index; and
during execution of the structured RAG query, retrieve the aggregated ontology element from the ontology index.

12. A method for use with a computing system, the method comprising:
extracting a plurality of ontology elements from a plurality of conversational turns, wherein the ontology elements are extracted from the conversational turns at least in part by executing a generative language model included in a machine learning system;
assigning a respective ontology element type to each of the ontology elements;
storing the ontology elements in an ontology index at one or more memory devices, wherein, within the ontology index, the ontology elements are organized according to their ontology element types;
receiving a user input to the machine learning system;
at the generative language model, computing a structured retrieval-augmented generation (RAG) query based at least in part on the user input;
executing the structured RAG query over the ontology index to obtain one or more retrieved ontology elements from the ontology index;
at the generative language model, computing a generative language model output based at least in part on the user input and the one or more retrieved ontology elements; and
outputting the generative language model output.

13. The method of claim 12, further comprising:
generating the structured RAG query to include one or more target ontology element types of the one or more retrieved ontology elements; and
during execution of the structured RAG query:
selecting a domain-specific agent from among a plurality of domain-specific agents based at least in part on the one or more target ontology element types; and
selecting the one or more retrieved ontology elements at least in part by executing the selected domain-specific agent.

14. The method of claim 13, wherein:
the ontology index includes respective domain ontology indices associated with the domain-specific agents; and
during execution of the structured RAG query, at least one of the one or more retrieved ontology elements is obtained from the domain ontology index of the selected domain-specific agent.

15. The method of claim 14, wherein, during extraction of the plurality of ontology elements from the plurality of conversational turns, the method further comprises:
at the generative language model, classifying at least a portion of the plurality of ontology elements into respective domains;
storing the classified ontology elements in the respective domain ontology indices of those domains.

16. The method of claim 11, wherein the structured RAG query is an exact-match search query for one or more of the ontology elements that have a target ontology element type.

17. The method of claim 16, further comprising:
determining that the structured RAG query returns no exact matches to the target ontology element type; and
in response to determining that the structured RAG query returns no exact matches:
computing a plurality of cosine similarity values between respective embeddings of:
the target ontology element type; and
respective ontology elements stored in the ontology index; and
selecting, as the one or more retrieved ontology elements, one or more of the ontology elements that have cosine similarity values above a predefined cosine similarity threshold.

18. The method of claim 11, wherein extracting the ontology elements from the conversational turns includes:
inserting an extraction prompt fragment into a context of the generative language model; and
during the plurality of conversational turns, based at least in part on the context that includes the extraction prompt fragment, extracting the ontology elements in parallel with generation of respective responses.

19. The method of claim 11, wherein the ontology index has a hierarchical structure in which the ontology elements at a first level are indicated as facets of respective ontology elements at a second level.

20. A computing system comprising:
one or more memory devices storing an ontology index, wherein:
within the ontology index, a plurality of ontology elements are organized according to respective ontology element types;
the ontology index includes respective domain ontology indices associated with a plurality of domain-specific agents; and
one or more processing devices configured to:
receive a user input to a machine learning system;
at a generative language model, compute a structured retrieval-augmented generation (RAG) query based at least in part on the user input, wherein the structured RAG query includes one or more target ontology element types;
execute the structured RAG query over the ontology index to obtain, from the ontology index, one or more retrieved ontology elements that respectively have the one or more target ontology element types, wherein executing the structured RAG query includes:
selecting a domain-specific agent from among a plurality of domain-specific agents based at least in part on the one or more target ontology element types; and
selecting the one or more retrieved ontology elements at least in part by executing the selected domain-specific agent;
at the generative language model, compute a generative language model output based at least in part on the user input and the one or more retrieved ontology elements; and
output the generative language model output.
